(19) United States
(12) Patent Application Publication
(10) Pub. No.: US 2025/0321607 A1
(43) Pub. Date: Oct. 16, 2025

(54) OPERATION DEVICE

(71) Applicant: KABUSHIKI KAISHA TOKAI RIKA DENKI SEISAKUSHO, Aichi (JP)

(72) Inventors: Masaki HYODO, Aichi (JP); Taiyo UMEDA, Aichi (JP); Hidetaka NOMURA, Aichi (JP); Terumasa SUYAMA, Aichi (JP); Yosuke HATADA, Aichi (JP); Sota SUZUKI, Aichi (JP)

(73) Assignee: KABUSHIKI KAISHA TOKAI RIKA DENKI SEISAKUSHO, Aichi (JP)

(21) Appl. No.: 18/864,962

(22) PCT Filed: Aug. 10, 2023
(86) PCT No.: PCT/JP2023/029238

§ 371 Date: Nov. 12, 2024

(30) Foreign Application Priority Data
Aug. 12, 2022 (JP) 2022-128575

(51) Int. Cl. G05G 9/02; G05G 1/015

(52) U.S. Cl. CPC G05G 9/02; G05G 1/015

(57) ABSTRACT

An operation device including a main body including plural shapes formed on a lateral surface and including plural switching points where the shapes are switched on a circumference of an end surface intersecting the lateral surface, and a rotating operation unit that is rotatably attached to the end surface of the main body, includes plural attachment-side shapes formed on an attachment-side lateral surface along a rotation axis, includes plural attachment-side switching points at which the attachment-side shapes are switched on a circumference of an attachment-side end surface facing the end surface of the main body, and includes plural operating positions, including an initial operating position, associated with a rotating operation, the operating positions other than the initial operating position including at least one operating position at which at least one of the switching points is aligned with the attachment-side switching point, and at least one operating position with no alignment.

### CROSS-REFERENCE TO RELATED APPLICATIONS

The present patent application claims the priority of Japanese patent application No. 2022/128575 filed on Aug. 12, 2022, and the entire contents of Japanese patent application No. 2022/128575 are hereby incorporated by reference.

### TECHNICAL FIELD

The present invention relates to an operation device.

### BACKGROUND ART

A vehicle lever switch is known which includes a substantially semi-cylindrical shaped first knob and a substantially cylindrical shaped rotating operation unit rotatably mounted on the front end of the first knob (see, e.g., PTL 1).

This vehicle lever switch has an integral design since the rotating operation unit has a shape which looks as if it is extended from the first knob.

### CITATION LIST

### Patent Literatures

PTL 1: JP 2012/069315 A

### SUMMARY OF INVENTION

With the vehicle lever switch disclosed in PTL 1, the operation of the rear wiper is switched from the resting state to the intermittent operation or normal operation by rotating the rotating operation unit. However, the problem is that it is not easy for users to identify the operating position of the rotating operation unit since how the first knob and the rotating operation unit look changes by touching, or rotating operation. Particularly, with the conventional vehicle lever switch, it is difficult to allow users to easily identify only a specific operating position.

It is an object of the invention to provide an operation device that can improve identifiability of a specific operating position.

According to an embodiment of the invention, an operation device comprises:
a main body comprising a plurality of shapes formed on a lateral surface and comprising a plurality of switching points at which the plurality of shapes are switched on a circumference of an end surface intersecting the lateral surface; and
a rotating operation unit that is rotatably attached to the end surface of the main body, comprises a plurality of attachment-side shapes formed on an attachment-side lateral surface extending along a rotation axis, comprises a plurality of attachment-side switching points at which the plurality of attachment-side shapes are switched on a circumference of an attachment-side end surface facing the end surface of the main body, and comprises a plurality of operating positions, including an initial operating position, associated with a rotating operation, the plurality of operating positions other than the initial operating position comprising at least one operating position at which at least one of the switching points is aligned with the attachment-side switching point, and at least one operating position with no alignment.

### Advantageous Effects of Invention

According to an embodiment of the invention, it is possible to provide an operation

device that can improve identifiability of a specific operating position.

### BRIEF DESCRIPTION OF DRAWINGS

FIG. 1A is an explanatory diagram illustrating a vehicle in which an operation device in a first embodiment is arranged.

FIG. 1B is an explanatory diagram illustrating the operation device in the first embodiment.

FIG. 1C is a block diagram illustrating the operation device in the first embodiment.

FIG. 2A is an explanatory diagram illustrating an operation of the operation device in the first embodiment.

FIG. 2B is an explanatory diagram illustrating the operation of the operation device in the first embodiment.

FIG. 2C is an explanatory diagram illustrating the operation of the operation device in the first embodiment.

FIG. 3A is an explanatory diagram illustrating an end surface of the operation device in the first embodiment.

FIG. 3B is an explanatory diagram illustrating an attachment-side end surface of the operation device in the first embodiment.

FIG. 4A is an explanatory diagram illustrating the operation of the operation device in a second embodiment.

FIG. 4B is an explanatory diagram illustrating the operation of the operation device in the second embodiment.

FIG. 5A is an explanatory diagram illustrating the end surface of the operation device in the second embodiment.

FIG. 5B is an explanatory diagram illustrating the attachment-side end surface of the operation device in the second embodiment.

FIG. 6A is an explanatory diagram illustrating a tapered-shaped rotating operation unit of the operation device in a third embodiment.

FIG. 6B is an explanatory diagram illustrating a bent-shaped lever body of the operation device in the third embodiment.

### DESCRIPTION OF EMBODIMENTS

### Summary of the Embodiments

An operation device in the embodiment has a main body having plural shapes formed on a lateral surface and having plural switching points at which the plural shapes are switched on a circumference of an end surface intersecting the lateral surface, and a rotating operation unit that is rotatably attached to the end surface of the main body, has plural attachment-side shapes formed on an attachment-side lateral surface extending along a rotation axis, has plural attachment-side switching points at which the plurality of attachment-side shapes are switched on a circumference of an attachment-side end surface facing the end surface of the main body, and has plural operating positions, including an initial operating position, associated with a rotating operation, where the plural operating positions other than the initial operating position include at least one operating position at which at least one of the switching points is aligned with the attachment-side switching point, and at least one operating position with no alignment.

This operation device makes users feel the main body and the rotating operation unit as a single unit when touching or looking at them since the switching point is aligned with the attachment-side switching point. Therefore, as compared to the case where this configuration is not adopted, identifiability of a specific operating position at the time of alignment can be improved.

### First Embodiment

### General Configuration of an Operation Device 1

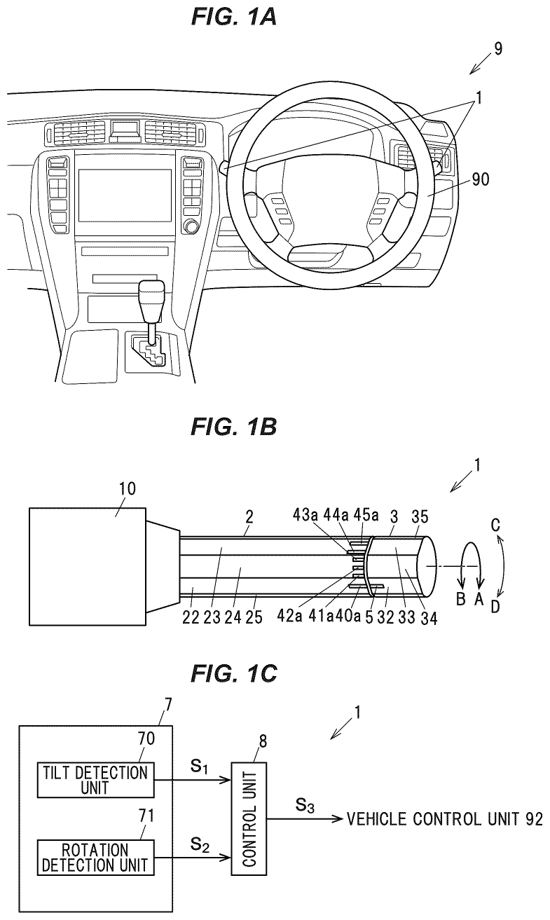

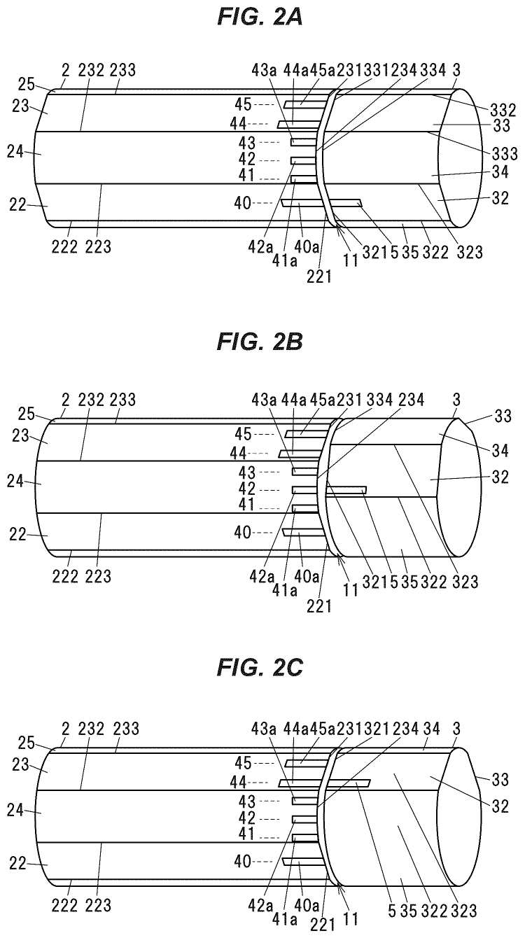

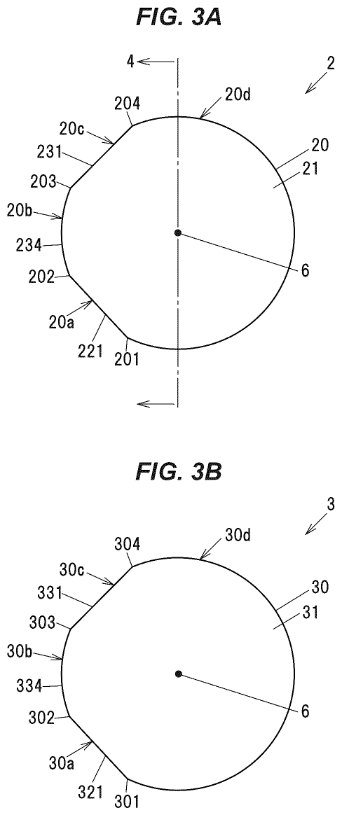

FIG. 1A is an explanatory diagram illustrating a vehicle in which an operation device in the first embodiment is arranged, FIG. 1B is an explanatory diagram illustrating the operation device, and FIG. 1C is a block diagram illustrating the operation device. FIGS. 2A to 2C are explanatory diagrams illustrating the operation device in the first embodiment to explain an operation from an initial operating position to another operating position. FIG. 3A is an end surface of a main body of the operation device in the first embodiment, and FIG. 3B is an explanatory diagram illustrating an attachment-side end surface of a rotating operation unit. In the drawings of the embodiments described below, a scale ratio or shape may be different between the drawings or different from an actual ratio or shape. In addition, in FIG. 1C, flows of main information are indicated by arrows.

As an example, the operation devices 1 in the first embodiment are arranged on the left and right sides behind a steering wheel 90 of a vehicle 9 as viewed by a driver, as shown in FIG. 1A. As an example, the left operation device 1 is a lever operation device that mainly drives a wiper device of the vehicle 9. As an example, the right operation device 1 is a lever operation device that mainly operates direction indicator lights of the vehicle 9. In the following description, the right operation device 1 will be mainly described. In this regard, the operation device 1 is not limited to the lever operation device and may be an operation device configured such that only a rotating operation unit 3 can be operated.

As shown in FIGS. 1B to 3B, the operation device 1 has a lever body 2 as the main body having plural shapes formed on a lateral surface 20 and having plural switching points at which the plural shapes are switched on a circumference of an end surface 21 intersecting the lateral surface 20, and the rotating operation unit 3 that is rotatably attached to the end surface 21 of the lever body 21, has plural attachment-side shapes formed on an attachment-side lateral surface 30 extending along a rotation axis 6, has plural attachment-side switching points at which the plural attachment-side shapes are switched on a circumference of an attachment-side end surface 31 facing the end surface 21 of the lever body 2, and has plural operating positions, including an initial operating position 40, associated with a rotating operation, where the plural operating positions other than the initial operating position 40 include at least one operating position at which at least one of the switching points is aligned with the attachment-side switching point, and at least one operating position with no alignment. As described later, at least one operating position with alignment in the first embodiment is, but not limited to, the initial operating position 40 and a fifth operating position 44, as an example. Then, at least one operating position with no alignment is, but not limited to, second to fourth operating positions 41 to 43 and a sixth operating operation position 45, as an example.

The solid line shown in FIG. 3A indicates the circumference of the end surface 21 of the lever body 2. The solid line shown in FIG. 3B indicates the circumference of the attachment-side end surface 31 of the rotating operation unit 3. The end surface 21 and the attachment-side end surface 31 have the same shape, but a back surface 25 and an attachment-side back surface 35 may have different shapes.

As shown in FIG. 3A, the lever body 2 has a first switching point 201 and a second switching point 202 as the plural switching points. Meanwhile, the rotating operation unit 3 has a first attachment-side switching point 301 and a second attachment-side switching point 302 as the plurality of attachment-side switching points, and in the initial operating position 40, the first switching point 201 is aligned with the first attachment-side switching point 301 and the second switching point 202 with the second attachment-side switching point 302, as shown in FIGS. 2A and 3B.

As shown in FIGS. 2A and 3A, the lever body 2 has a first surface 22 having a first edge 221 that is a straight line connecting the first switching point 201 and the second switching point 202, a second edge 222 that is originated from the first switching point 201 and extends along the rotation axis 6, and a third edge 223 that is originated from the second switching point 202 and extends along the rotation axis 6. The rotating operation unit 3 has a first attachment-side surface 32 having a first attachment-side edge 321 that is a straight line connecting the first attachment-side switching point 301 and the second attachment-side switching point 302, a second attachment-side edge 322 that is originated from the first attachment-side switching point 301 and extends along the rotation axis 6, and a third attachment-side edge 323 that is originated from the second attachment-side switching point 302 and extends along the rotation axis 6. When the rotating operation unit 3 of the operation device 1 is in the initial operating position 40, the first surface 22 and the first attachment-side surface 32 constitute one surface with the first edge 221 and the first attachment-side edge 321 in-between.

The lever body 2 further has a third switching point 203 and a fourth switching point 204 as the plural switching points. The rotating operation unit 3 further has a third attachment-side switching point 303 and a fourth attachment-side switching point 304 as the plural attachment-side switching points, and in the initial operating position 40, the first switching point 201 is aligned with the first attachment-side switching point 301, the second switching point 202 with the second attachment-side switching point 302, the third switching point 203 with the third attachment-side switching point 303, and the fourth switching point 204 with the fourth attachment-side switching point 304, as shown in FIG. 2A.

As shown in FIGS. 2A and 3A, the lever body 2 has a second surface 23 having a fourth edge 231 that is a straight line connecting the third switching point 203 and the fourth switching point 204, a fifth edge 232 that is originated from the third switching point 203 and extends along the rotation axis 6, and a sixth edge 233 that is originated from the fourth switching point 204 and extends along the rotation axis 6. As shown in FIGS. 2A and 3B, the rotating operation unit 3 has a second attachment-side surface 33 having a fourth attachment-side edge 331 that is a straight line connecting the third attachment-side switching point 303 and the fourth attachment-side switching point 304, a fifth attachment-side edge 332 that is originated from the third attachment-side switching point 303 and extends along the rotation axis 6, and a sixth attachment-side edge 333 that is originated from the fourth attachment-side switching point 304 and extends along the rotation axis 6. When the rotating operation unit 3 of the operation device 1 is in the initial operating position 40, the first surface 22 and the first attachment-side surface 32 constitute one surface with the first edge 221 and the first attachment-side edge 321 in-between, and the second surface 23 and the second attachment-side surface 33 constitute one surface with the fourth edge 231 and the fourth attachment-side edge 331 in-between.

The lever body 2 in the first embodiment has a lever shape. As shown in FIG. 1B, the lever body 2 is attached so that tilt operation of tilting the lever body 2 can be performed in at least two directions, and the operation device 1 includes a detection unit 7 to detect the tilt operation of the lever body 2 and the plural operating positions of the rotating operation unit 3.

The operation device 1 includes a control unit 8 that generates operation information S3 based on a detection result of the detection unit 7 and outputs the operation information S3 to a vehicle control unit 92 that comprehensively controls the vehicle 9. The vehicle control unit 92 is, e.g., a microcomputer that comprehensively controls the vehicle 9.

### Configuration of the Lever Body 2

As shown in FIG. 1B, the lever body 2 is attached to a housing 10. The lever body 2 can be tilted in the direction of arrow C and the direction of arrows D relative to the housing 10. A tilt operation in the direction of the arrow C is an operation direction to turn on the left direction indicator lights of the vehicle 9. Then, a tilt operation in the direction of the arrow D is an operation direction to turn on the right direction indicator lights of the vehicle 9. The housing 10 is attached to a column of the steering wheel 90. In this regard, the lever body 2 may be configured to be operable not only in the direction of the arrow C which is the upward direction on the paper surface of FIG. 1B and the direction of arrow D which is the downward direction on the paper surface, but also in the direction toward the front of the paper surface and the direction toward the back of the paper surface which intersect therewith.

The lever body 2 has an elongated, substantially circular column shape, as an example. On the lateral surface 20 thereof, first to fourth shapes 20a to 20d, as the plural shapes, are provided along the rotation axis 6.

The first shape 20a is the first surface 22 that is an elongated flat surface, as shown in FIGS. 2A to 2C. The first surface 22 is a flat surface surrounded by the first edge 221, the second edge 222 and the third edge 223, as described above. A rectangular initial design 40a indicating the initial operating position 40 is provided on the first surface 22.

The second shape 20b is an intermediate surface 24 that is an elongated curved surface. As shown in FIG. 3A, the intermediate surface 24 has a curved seventh edge 234 connecting the second switching point 202 and the third switching point 203 when viewed from the end surface 21, and continues from the end surface 21 to the housing 10. Rectangular designs 41a to 43a indicating the second to fourth operating positions 41 to 43 are provided on the intermediate surface 24. The designs 41a to 43a have a rectangular shape with a shorter length than the initial design 40a.

The third shape 20c is the second surface 23 that is an elongated flat surface. The second surface 23 is a flat surface surrounded by the fourth edge 231, the fifth edge 232 and the sixth edge 233, as described above. Rectangular designs 44a and 45a indicating the fifth and sixth operating positions 44 and 45 are provided on the second surface 23. The designs 44a and 45a have a rectangular shape longer than the designs 41a to 44a.

As shown in FIG. 3A, the fourth shape 20d is the back surface 25 having a curved surface that directly connects the first switching point 201 to the fourth switching point 204, not on the second and third switching points 202, 203 side. The back surface 25 continues from the end surface 21 to the housing 10.

The first to fourth shapes 20a to 20d in the first embodiment form an outer shape such that the first shape 20a and the third shape 20c are formed by cutting out a perfect circle centered at the rotation axis 6, i.e., the lateral surface 20 of the circular column, along the rotation axis 6, as an example.

When the lever body 2 is viewed from the driver's side, a visible area 4 based on a straight line passing through the rotation axis 6 as shown in FIG. 3A is in front of the driver and is an area which can be seen easily. In other words, the back surface 25, which is the back side of the lever body 2, is not easy for the driver to see. Therefore, the first to third shapes 20a to 20c are provided in the visible area 4.

The length between the first switching point 201 and the second switching point 202 is equal to the length between the third switching point 203 and the fourth switching point 204. In other words, the lengths of the first edge 221 and the fourth edge 231 are equal. Then, the length of a straight line directly connecting the second switching point 202 and the third switching point 203 is different from the lengths of the first edge 221 and the fourth edge 231.

### Configuration of the Rotating Operation Unit 3

The rotating operation unit 3 is rotatably attached to the lever body 2. The rotating operation unit 3 can be rotated in the direction of arrow A from the initial operating position 40 to the sixth operating position 45. The rotating operation unit 3 can also be rotated in the direction of arrow B from the sixth operating position 45 to the initial operating position 40. The rotating operation unit 3 has a substantially circular column shape that is shorter than the lever body 2.

The rotating operation unit 3 is, e.g., to turn on and off headlamps of the vehicle 9 and has the initial operating position 40 and the second to sixth operating positions 41 to 45. The initial operating position 40 is the operating position where the headlamps are turned off. The second to fourth operating positions 41 to 43 are, e.g., operating positions related to plural automatic modes, such as automatically switching between high beam and low beam according to the surrounding environment or vehicle speed, illuminating the direction of travel when driving a curve, adjusting the illumination range of the low beam according to the distance to the vehicle ahead, and turning on fog lamps, etc. according to the weather. The fifth operating position 44 is the operating position to turn the headlamps into the low beam. The sixth operating position 45 is the operating position to turn the headlamps into the high beam.

The rotating operation unit 3 has a mark 5, as shown in FIG. 2A. The mark 5 has a rectangular shape and is provided on the first attachment-side surface 32.

When the mark 5 is aligned with the initial design 40a which indicates the initial operating position 40, it indicates that the operating position of the rotating operation unit 3 is the initial operating position 40. Similarly, when the mark 5 points to any one of the designs 41 a to 45a, it indicates that the rotating operation unit 3 has been operated to the operating position pointed by the mark 5.

A first attachment-side shape 30a is the first attachment-side surface 32 that is an elongated flat surface, as shown in FIGS. 2A to 2C. The first attachment-side surface 32 is a flat surface surrounded by the first attachment-side edge 321, the second attachment-side edge 322 and the third attachment-side edge 323, as described above. The mark 5 is provided on the first attachment-side surface 32.

A second attachment-side shape 30b is an attachment-side intermediate surface 34 that is an elongated curved surface. As shown in FIG. 3B, the attachment-side intermediate surface 34 is a curved surface with a curved seventh attachment-side edge 334 connecting the second attachment-side switching point 302 and the third attachment-side switching point 303 when viewed from the attachment-side end surface 31.

A third attachment-side shape 30c is the second attachment-side surface 33 that is an elongated flat surface. The second attachment-side surface 33 is a flat surface surrounded by the fourth attachment-side edge 331, the fifth attachment-side edge 332 and the sixth attachment-side edge 333, as described above.

As shown in FIG. 3B, a fourth attachment-side shape 30d is the attachment-side back surface 35 having a curved surface that directly connects the first attachment-side switching point 301 to the fourth attachment-side switching point 304, not on the second and third attachment-side switching points 302, 303 side.

The first to fourth attachment-side shapes 30a to 30d in the first embodiment have shapes that are different in length from but are symmetrical to the first to fourth shapes 20a to 20d of the lever body 2. In other words, when the rotating operation unit 3 is operated to the initial operating position 40, the first surface 22 and the first attachment-side surface 32 form a continuous surface with the gap 11 in-between, and the second surface 23 and the second attachment-side surface 33, the intermediate surface 24 and the attachment-side intermediate surface 34, the back surface 25 and the attachment-side back surface 35, respectively form continuous surfaces with the gap 11 in-between.

Thus, the first to fourth attachment-side shapes 30a to 30d form an outer shape such that the first attachment-side shape 30a and the third attachment-side shape 30c are formed by cutting out a perfect circle centered at the rotation axis 6, i.e., the attachment-side lateral surface 30 of the circular column, along the rotation axis 6, as an example.

The length between the first attachment-side switching point 301 and the second attachment-side switching point 302 is equal to the length between the third attachment-side switching point 303 and the fourth attachment-side switching point 304. In other words, the lengths of the first attachment-side edge 321 and the fourth attachment-side edge 331 are equal. Then, the length of a straight line directly connecting the second attachment-side switching point 302 and the third attachment-side switching point 303 is different from the lengths of the first attachment-side edge 321 and the fourth attachment-side edge 331.

In addition, the lengths of the first edge 221 and the first attachment-side edge 321 are equal. Moreover, the lengths of the fourth edge 231 and the fourth attachment-side edge 331 are equal. Thus, the first edge 221, the fourth edge 231, the first attachment-side edge 321 and the fourth attachment-side edge 331 are equal in length. Then, the seventh edge 234 has the same shape and length as the seventh attachment-side edge 334.

### The Operating Positions

As shown in FIG. 2C, when the rotating operation unit 3 is in an operating position different from the initial operating position 40, the second surface 23 and the first attachment-side surface 32 constitute one surface with the fourth edge 231 and the first attachment-side edge 321 in-between. In the first embodiment, when the rotating operation unit 3 is operated to the fifth operating position 44, the second surface 23 is aligned with the first attachment-side surface 32. The first surface 22 and the intermediate surface 24 are located opposite the attachment-side back surface 35. Therefore, when looking at the lever body 2 and the rotating operation unit 3, the driver can easily visually check in which operating position the rotating operation unit 3 is located.

Regarding the case of operating the rotating operation unit 3 to the initial operating position 40 and the fifth operating position 44 as shown in FIGS. 2A and 2C, and when in the initial operating position 40, the first surface 22 is opposite the first attachment-side surface 32 and the second surface 23 opposite the second attachment-side surface 33.

In particular, when the rotating operation unit 3 is operated to the initial operating position 40, the first surface 22 is flush with the first attachment-side surface 32, the intermediate surface 24 is flush with the attachment-side intermediate surface 34, the second surface 23 is flush with the second attachment-side surface 33, and the back surface 25 is flush with the attachment-side back surface 35, as shown in FIG. 2A.

When the rotating operation unit 3 is operated to the fifth operating position 44, the second surface 23 is flush with the first attachment-side surface 32, as shown in FIG. 2C.

That is, when the rotating operation unit 3 is operated to the initial operating position 40, the first surface 22 and the first attachment-side surface 32, also the second surface 23 and the second attachment-side surface 33, are partially symmetrical with respect to the gap 11, and the shapes partially coincide when folded back from the gap 11. Furthermore, when the rotating operation unit 3 is operated to the fifth operating position 44, the second surface 23 and the first attachment-side surface 32 are partially symmetrical with respect to the gap 11, and the shapes partially coincide when folded back from the gap 11.

Therefore, by touching or moving the line of sight, the driver can easily identify mainly whether the first attachment-side surface 32 having the mark 5 is flush with the first surface 22 or flush with the second surface 23 as shown in FIGS. 2A and 2C, and can easily identify whether it is in the initial operating position 40 or the fifth operating position 44. The operability of the operation device 1 is improved particularly when the fifth operating position 44 is a highly frequently or often used operating position.

Meanwhile, when in an operating position other than the initial operating position 40 and the fifth operating position 44, the rotating operation unit 3 has no surfaces which are flush with the first surface 22, the intermediate surface 24 and the second surface 23 of the lever body 2, as shown in FIG. 2B. Therefore, since the surfaces are not aligned, the driver can easily identify by touching or moving the line of sight that the operation to an operating position other than the initial operating position 40 and the fifth operating position 44 has been performed.

### Configuration of the Detection Unit 7

As an example, the detection unit 7 includes a tilt detection unit 70 to detect a tilt operation of the lever body 2, and a rotation detection unit 71 to detect the operating position of the rotating operation unit 3, as shown in FIG. 1C. The tilt detection unit 70 and the rotation detection unit 71 are arranged on the housing 10 as an example, but are not limited to thereto. For example, the rotation detection unit 71 may be arranged on the lever body 2.

The tilt detection unit 70 detects a tilt operation of the lever body 2 and outputs tilt operation information S₁, which includes information about the detected tilt operation, to the control unit 8.

The rotation detection unit 71 detects the operating position of the rotating operation unit 3 and outputs operating position information S2, which includes information about the detected operating position, to the control unit 8.

### Configuration of the Control Unit 8

The control unit 8 is, e.g., a microcomputer composed of a CPU (Central Processing Unit) performing calculation and processing, etc., of the acquired data according to a stored program, and a RAM (Random Access Memory) and a ROM (Read Only Memory) as semiconductor memories, etc. The ROM stores, e.g., a program for operation of the control unit 8. The RAM is used as, e.g., a storage area to temporarily store calculation results, etc.

The control unit 8 is arranged on the housing 10 as an example, but is not limited thereto. The control unit 8 outputs the operation information S₃ to the vehicle control unit 92 based on the tilt operation information S₁ and the operating position information S₂.

### Effects of the First Embodiment

The operation device 1 in the first embodiment can improve identifiability of specific operating positions. In particular, the operating device 1 is configured such that the first surface 22 is aligned with the first attachment-side surface 32, the intermediate surface 24 with the attachment-side intermediate surface 34, and the second surface 23 with the second attachment-side surface 33 when in the initial operating position 40. Therefore, as compared to the case where this configuration is not adopted, the driver can easily identify by touching or looking at the external appearance that the rotating operation unit 3 is located at the initial operating position 40. Likewise, the operating device 1 is configured such that the second surface 23 is aligned with the first attachment-side surface 32 when in the fifth operating position 44. Therefore, as compared to the case where this configuration is not adopted, the driver can easily identify by touching or looking at the external appearance that the rotating operation unit 3 is located at the fifth operating position 44. Therefore, when the initial operating position 40 and the fifth operating position 44 are specific operating positions particularly desired to have high identifiability, the identifiability thereof is higher than other operating positions, and when the operating device 1 is operated to an operating position other than the initial operating position 40 and the fifth operating position 44, identifiability of this operating position is also improved.

The operation device 1 is configured such that two surface alignments are achieved provided when located at the initial operating position 40 and one surface alignment is achieved when located at the fifth operating position 44. Therefore, identifiability when touching or looking at the external appearance is improved as compared to the case where this configuration is not adopted.

When, e.g., the first attachment-side surface side 32 is located on a line extended from the fifth edge 232 as shown in FIG. 2B, the operation device 1 is easy for the user to identify that the rotating operation unit 3 is operated to any one of the second to fourth operating positions 41 to 43, not just a particular operating position. Similarly, when the attachment-side back surface 35 is located on lines extended from the third edge 223 and the fifth edge 232, the operation device 1 is easy for the user to identify that the rotating operation unit 3 is operated to the sixth operating position 45, not just a particular operating position. Therefore, the operation device 1 has high identifiability not only for specific operating positions but also for other operating positions at which the switching points of the lever body 2 are not aligned with the attachment-side switching points of the rotating operation unit 3, i.e., at which the surfaces of the lever body 2 are not aligned with the attachment-side surfaces of the rotating operation unit 3.

As a modification, the operation device 1 may be configured such that even more surfaces are aligned.

### Second Embodiment

The second embodiment differs from the first embodiment in that one surface alignment is achieved.

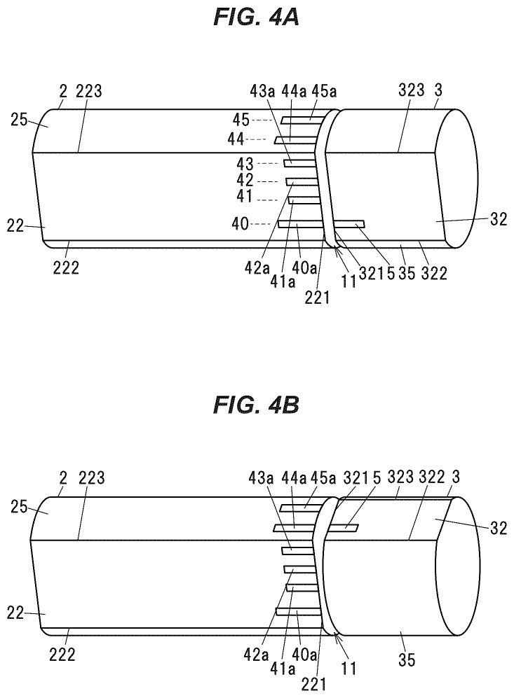

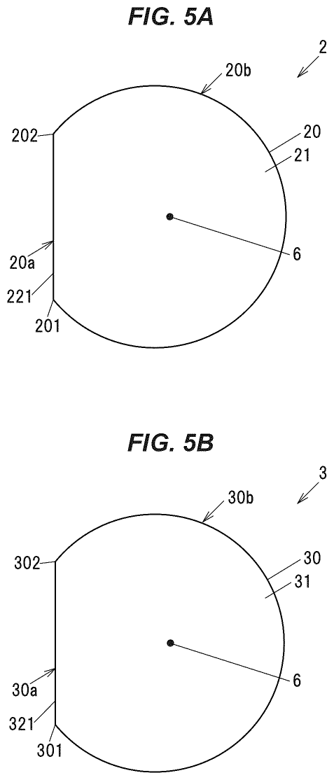

FIGS. 4A and 4B are diagrams illustrating the operation device in the second embodiment to explain the operation from the initial operating position to the fifth operating position. FIG. 5A is the end face of the main body of the operation device in the second embodiment, and FIG. 5B is a diagram illustrating the attachment-side end surface of the rotating operation unit. In the embodiments described below, portions having the same function and configuration as those in the first embodiment are denoted by the same reference numerals and the explanation thereof will be omitted.

As shown in FIG. 5A, the lever body 2 has the first switching point 201 and the second switching point 202 as the plural switching points. The rotating operation unit 3 has the first attachment-side switching point 301 and the second attachment-side switching point 302 as the plurality of attachment-side switching points, as shown in FIG. 5B. The operation device 1 is configured such that the first switching point 201 is aligned with the first attachment-side switching point 301 and the second switching point 202 with the second attachment-side switching point 302 when in the initial operating position 40.

As shown in FIGS. 4A and 5A, the lever body 2 has the first surface 22 having the first edge 221 that is a straight line connecting the first switching point 201 and the second switching point 202, the second edge 222 that is originated from the first switching point 201 and extends along the rotation axis 6, and the third edge 223 that is originated from the second switching point 202 and extends along the rotation axis 6. The rotating operation unit 3 has the first attachment-side surface 32 having the first attachment-side edge 321 that is a straight line connecting the first attachment-side switching point 301 and the second attachment-side switching point 302, the second attachment-side edge 322 that is originated from the first attachment-side switching point 301 and extends along the rotation axis 6, and the third attachment-side edge 323 that is originated from the second attachment-side switching point 302 and extends along the rotation axis 6. When the rotating operation unit 3 of the operation device 1 is in the initial operating position 40, the first surface 22 and the first attachment-side surface 32 constitute one surface with the first edge 221 and the first attachment-side edge 321 in-between.

The circumference of the end surface 21 of the lever body 2 is divided into the first shape 20a and the second shape 20b by the first switching point 201 and the second switching point 202. The lever body 2 has an outer shape such that the first shape 20a is formed by cutting out a perfect circle centered at the rotation axis 6, i.e., the lateral surface 20 of the circular column, along the rotation axis 6. The first shape 20a is the first surface 22 that is a flat surface. The second shape 20b is the back surface 25 having a curved surface that directly connects the first switching point 201 to the second switching point 202, as shown in FIG. 5A.

The circumference of the attachment-side end surface 31 of the rotating operation unit 3 is divided into the first attachment-side shape 30a and the second attachment-side shape 30b by the first attachment-side switching point 301 and the second attachment-side switching point 302. The rotating operation unit 3 has an outer shape such that the first attachment-side shape 30a is formed by cutting out a perfect circle centered at the rotation axis 6, i.e., the attachment-side lateral surface 30 of the circular column, along the rotation axis 6. The first attachment-side shape 30a is the first attachment-side surface 32 that is a flat surface. The second attachment-side shape 30b is the attachment-side back surface 35 having a curved surface that directly connects the first attachment-side switching point 301 to the second attachment-side switching point 302, as shown in FIG. 5B.

The rotating operation unit 3 in the second embodiment has an operating position which is an operating position rotated from the initial operating position 40 and at which a straight line extended from the third edge 223 coincides with the second attachment-side edge 322, as shown in FIGS. 4A and 4B.

This rotated operating position is the fifth operating position 44, as an example. When the rotating operation unit 3 is operated to the fifth operating position 44, there is no surface aligned with the first attachment-side surface 32 but the third edge 223 of the lever body 2 is aligned with the second attachment-side edge 322 of the rotating operation unit 3 with the gap 11 in-between as shown in FIG. 4B, hence, it looks as if the third edge 223 and the second attachment-side-edge 322 were a single straight line.

By touching or looking at the external appearance, the driver can identify that it is in the initial operating position 40 when the first surface 22 is flush with the first attachment-side surface 32, and can identify that it is in the fifth operating position 44 when the third edge 223 is aligned with the second attachment-side edge 322.

### Effects of the Second Embodiment

The operation device 1 in the second embodiment is configured such that the first surface 22 is aligned with the first attachment-side surface 32 when in the initial operating position 40. Therefore, as compared to the case where this configuration is not adopted, the driver can easily identify by touching or looking at the external appearance that the rotating operation unit 3 is located at the initial operating position 40. In addition, the operation device 1 is configured such that the third edge 223 of the lever body 2 is aligned with the second attachment-side edge 322 of the rotating operation unit 3 with the gap 11 in-between, hence, it looks as if the third edge 223 and the second attachment-side-edge 322 were a single straight line. Therefore, as compared to the case where this configuration is not adopted, the driver can easily identify by touching or looking at the external appearance that the rotating operation unit 3 is located at the fifth operating position 44. Therefore, when the initial operating position 40 and the fifth operating position 44 are specific operating positions particularly desired to have high identifiability, the identifiability thereof is higher than other operating positions, and when the operating device 1 is operated to an operating position other than the initial operating position 40 and the fifth operating position 44, identifiability of this operating position is also improved.

### Third Embodiment

The third embodiment differs from the other embodiments in the shapes of the lever body and the rotating operation unit.

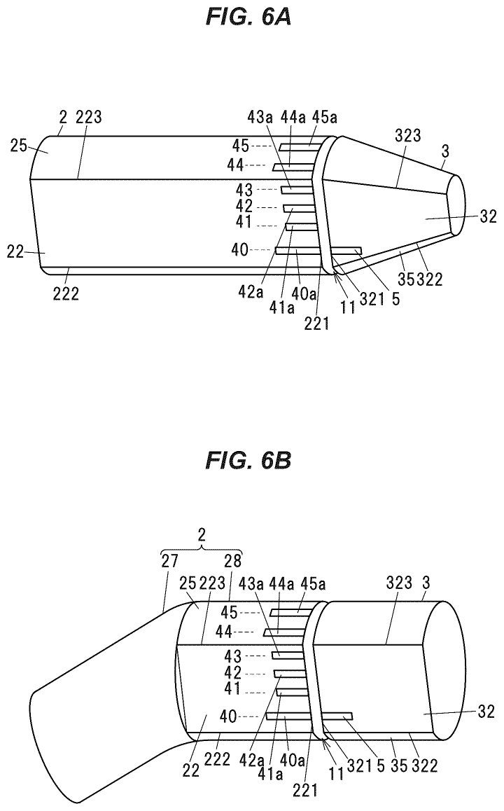

FIG. 6A is an explanatory diagram illustrating a tapered-shaped rotating operation unit of the operation device in the third embodiment, and FIG. 6B is an explanatory diagram illustrating a bent-shaped lever body of the operation device. The operation device 1 in the third embodiment is configured such that the first switching point 201 is aligned with the first attachment-side switching point 301 and the second switching point 202 with the second attachment-side switching point 302 when in the initial operating position 40, and the third edge 223 of the lever body 2 is aligned with the second attachment-side edge 322 of the rotating operation unit 3 with the gap 11 in-between when in the fifth operating position 44, in the same manner as the second embodiment. In this regard, the operation device 1 in the third embodiment may be configured such that two surface alignments are achieved when located at the initial operating position 40 and one surface alignment is achieved when located at the fifth operating position 44, in the same manner as the operation device 1 in the first embodiment.

In the other embodiments, the first surface 22 of the lever body 2 and the first attachment-side surface 32, also the second surface 23 and the second attachment-side surface 33, are partially symmetrical. The rotating operation unit 3 in the third embodiment has a tapered shape, and the first surface 22 and the first attachment-side surface 32 are not symmetrical even partially, as shown in FIG. 6A.

However, since the first switching point 201 is aligned with the first attachment-side switching point 301 and the second switching point 202 with the second attachment-side switching point 302 when the rotating operation unit 3 is operated to the initial operating position 40, the first surface 22 is aligned with the first attachment-side surface 32 and the driver can easily identify by touching or looking at the external appearance that the rotating operation unit 3 is located at the initial operating position 40. In addition, the operation device 1 is configured such that when in the fifth operating position 44, it looks as if the third edge 223 of the lever body 2 and the second attachment-side edge 322 of the rotating operation unit 3 were a line which bends at the gap 11 in the similar manner to the second embodiment. Therefore, as compared to the case where this configuration is not adopted, the driver can easily identify by touching or looking at the external appearance that the rotating operation unit 3 is located at the fifth operating position 44.

The lever body 2 of the operation device 1 shown in FIG. 6B includes a base portion 27 on the housing 10 side and a tip portion 28 bent from the base portion 27.

The first surface 22 of the operation device 1 in the other embodiment is present only on the tip portion 28 and thus has a shorter length, as shown in FIG. 6B. However, since the operation device 1 is configured such that the first surface 22 is aligned with the first attachment-side surface 32 when in the initial operating position 40, the driver can easily identify by touching or looking at the external appearance that the rotating operation unit 3 is located at the initial operating position 40. In addition, the operation device 1 is configured such that when in the fifth operating position 44, the third edge 223 of the lever body 2 is aligned with the second attachment-side edge 322 of the rotating operation unit 3 with the gap 11 in-between. Therefore, it looks as if the third edge 223 and the second attachment-side-edge 322 were a single straight line, and the driver can easily identify by touching or looking at the external appearance that the rotating operation unit 3 is located at the fifth operating position 44.

The operation device 1 in at least one of the embodiments described above can achieve improved identifiability of a specific operating position and also achieve high identifiability of other operating positions at which the switching points of the lever body 2 are not aligned with the attachment-side switching points of the rotating operation unit 3.

Although some embodiments and modifications of the invention have been described, these embodiments and modifications are merely examples and the invention according to claims is not to be limited thereto. These new embodiments and modifications may be implemented in various other forms, and various omissions, substitutions and changes, etc., can be made without departing from the gist of the invention. In addition, not all combinations of the features described in the embodiments and modifications are necessary to solve the problem of the invention. Further, these embodiments and modifications are included within the scope and gist of the invention and also within the invention described in the claims and the range of equivalency.

### REFERENCE SIGNS LIST

1 OPERATION DEVICE
2 LEVER BODY
3 ROTATING OPERATION UNIT
6 ROTATION AXIS
20 LATERAL SURFACE
20a-20d FIRST TO FOURTH SHAPES
21 END SURFACE
22 FIRST SURFACE
23 SECOND SURFACE
24 INTERMEDIATE SURFACE
30 ATTACHMENT-SIDE LATERAL SURFACE
30a-30d FIRST TO FOURTH ATTACHMENT-SIDE SHAPES
31 ATTACHMENT-SIDE END SURFACE
32 FIRST ATTACHMENT-SIDE SURFACE
33 SECOND ATTACHMENT-SIDE SURFACE
34 ATTACHMENT-SIDE INTERMEDIATE SURFACE
40 INITIAL OPERATING POSITION
41-45 SECOND TO SIXTH OPERATING POSITIONS
201-204 FIRST TO FOURTH SWITCHING POINTS
221-223 FIRST TO THIRD EDGES
231-234 FOURTH TO SEVENTH EDGES
301-304 FIRST TO FOURTH ATTACHMENT-SIDE SWITCHING POINTS
321-323 FIRST TO THIRD ATTACHMENT-SIDE EDGES
331-334 FOURTH TO SEVENTH ATTACHMENT-SIDE EDGES

1. An operation device, comprising:
a main body comprising a plurality of shapes formed on a lateral surface and comprising a plurality of switching points at which the plurality of shapes are switched on a circumference of an end surface intersecting the lateral surface; and
a rotating operation unit that is rotatably attached to the end surface of the main body, comprises a plurality of attachment-side shapes formed on an attachment-side lateral surface along a rotation axis, comprises a plurality of attachment-side switching points at which the plurality of attachment-side shapes are switched on a circumference of an attachment-side end surface facing the end surface of the main body, and comprises a plurality of operating positions, including an initial operating position, associated with a rotating operation, the plurality of operating positions other than the initial operating position comprising at least one operating position at which at least one of the switching points is aligned with the attachment-side switching point, and at least one operating position with no alignment.

2. The operation device according to claim 1, wherein the main body comprises a first switching point and a second switching point as the plurality of switching points, and wherein the rotating operation unit comprises a first attachment-side switching point and a second attachment-side switching point as the plurality of attachment-side switching points, and in the initial operating position, the first switching point is aligned with the first attachment-side switching point and the second switching point with the second attachment-side switching point.

3. The operation device according to claim 2, wherein the main body comprises a first surface comprising a first edge that is a straight line connecting the first switching point and the second switching point, a second edge that is originated from the first switching point and extends along the rotation axis, and a third edge that is originated from the second switching point and extends along the rotation axis, wherein the rotating operation unit comprises a first attachment-side surface comprising a first attachment-side edge that is a straight line connecting the first attachment-side switching point and the second attachment-side switching point, a second attachment-side edge that is originated from the first attachment-side switching point and extends along the rotation axis, and a third attachment-side edge that is originated from the second attachment-side switching point and extends along the rotation axis, and wherein when the rotating operation unit is in the initial operating position, the first surface and the first attachment-side surface constitute one surface with the first edge and the first attachment-side edge in-between.

4. The operation device according to claim 3, wherein the main body comprises a third switching point and a fourth switching point as the plurality of switching points, and wherein the rotating operation unit comprises a third attachment-side switching point and a fourth attachment-side switching point as the plurality of attachment-side switching points, and in the initial operating position, the first switching point is aligned with the first attachment-side switching point, the second switching point with the second attachment-side switching point, the third switching point with the third attachment-side switching point, and the fourth switching point with the fourth attachment-side switching point.

5. The operation device according to claim 4, wherein the main body comprises a second surface comprising a fourth edge that is a straight line connecting the third switching point and the fourth switching point, a fifth edge that is originated from the third switching point and extends along the rotation axis, and a sixth edge that is originated from the fourth switching point and extends along the rotation axis, wherein the rotating operation unit comprises a second attachment-side surface comprising a fourth attachment-side edge that is a straight line connecting the third attachment-side switching point and the fourth attachment-side switching point, a fifth attachment-side edge that is originated from the third attachment-side switching point and extends along the rotation axis, and a sixth attachment-side edge that is originated from the fourth attachment-side switching point and extends along the rotation axis, and wherein when the rotating operation unit is in the initial operating position, the first surface and the first attachment-side surface constitute one surface with the first edge and the first attachment-side edge in-between, and the second surface and the second attachment-side surface constitute one surface with the fourth edge and the fourth attachment-side edge in-between.

6. The operation device according to claim 5, wherein when the rotating operation unit is in an operating position different from the initial operating position, the second surface and the first attachment-side surface constitute one surface with the fourth edge and the first attachment-side edge in-between.

7. The operation device according to claim 4, wherein the main body comprises a second surface comprising a fourth edge that is a straight line connecting the third switching point and the fourth switching point, a fifth edge that is originated from the third switching point and extends along the rotation axis, and a sixth edge that is originated from the fourth switching point and extends along the rotation axis, and also comprises an intermediate surface connecting the second switching point and the third switching point and comprising a seventh edge curved as viewed from the end surface side, the third edge and the fifth edge, wherein the rotating operation unit comprises a second attachment-side surface comprising a fourth attachment-side edge that is a straight line connecting the third attachment-side switching point and the fourth attachment-side switching point, a fifth attachment-side edge that is originated from the third attachment-side switching point and extends along the rotation axis, and a sixth attachment-side edge that is originated from the fourth attachment-side switching point and extends along the rotation axis, and also comprises an attachment-side intermediate surface connecting the second attachment-side switching point and the third attachment-side switching point and comprising a seventh attachment-side edge curved as viewed from the attachment-side end surface side, the third attachment-side edge and the fifth attachment-side edge, and wherein when the rotating operation unit is in the initial operating position, the first surface and the first attachment-side surface constitute one surface with the first edge and the first attachment-side edge in-between, the second surface and the second attachment-side surface constitute one surface with the fourth edge and the fourth attachment-side edge in-between, and the intermediate surface and the attachment-side intermediate surface constitute one surface with the seventh edge and the seventh attachment-side edge in-between.

8. The operation device according to claim 7, wherein when the rotating operation unit is in an operating position different from the initial operating position, the second surface and the first attachment-side surface constitute one surface with the fourth edge and the first attachment-side edge in-between.

9. The operation device according to claim 3, wherein the rotating operation unit comprises an operating position which is an operating position rotated from the initial operating position and at which a straight line extended from the third edge coincides with the first attachment-side edge.

10. The operation device according to claim 1, wherein the main body has a lever shape, and wherein the main body is attached so that tilt operation of tilting the main body can be performed in at least two directions, and the device comprises a detection unit to detect the tilt operation of the main body and the plurality of operating positions of the rotating operation unit.
